(19) United States
(12) Patent Application Publication
(10) Pub. No.: US 2022/0413677 A1
(43) Pub. Date: Dec. 29, 2022

(54) TOUCH PANEL, AND DISPLAY DEVICE

(71) Applicants: Chengdu BOE Optoelectronics Technology Co., Ltd., Chengdu (Sichuan) (CN); BOE Technology Group Co., Ltd., Beijing (CN)

(72) Inventors: Guiyu ZHANG, Beijing (CN); Hongqiang LUO, Beijing (CN); KwangGyun JANG, Beijing (CN); Yichen JIANG, Beijing (CN)

(21) Appl. No.: 17/777,778

(22) PCT Filed: Jan. 7, 2021
(86) PCT No.: PCT/CN2021/070660

§ 371 Date: May 18, 2022

(30) Foreign Application Priority Data
Jan. 9, 2020 (CN) 202010021548.X

(51) Int. Cl. G06F 3/041

(52) U.S. Cl. CPC G06F 3/04164; G06F 2203/04111; G06F 2203/04107; G06F 3/0448

(57) ABSTRACT

The present disclosure provides a touch panel and a display device. The touch panel includes: a base substrate and a touch electrode layer. The touch electrode layer includes: multiple touch electrodes and multiple dummy electrodes, the dummy electrodes are insulated from the touch electrodes, and at least a portion of the dummy electrodes in the touch electrode layer are grounded.

### CROSS REFERENCE TO RELATED APPLICATIONS

The present application is a National Stage of International Application No. PCT/CN2021/070660, filed Jan. 7, 2021, which claims priority from Chinese Patent Application No. 202010021548.X, filed with the China National Intellectual Property Administration on Jan. 9, 2020, entitled “TOUCH PANEL AND DISPLAY APPARATUS”, the entire contents of which are incorporated herein by reference.

### FIELD

The present disclosure relates to the technical field of touch display, in particular to a touch panel and a display apparatus.

### BACKGROUND

A touch panel is generally used in combination with a display panel, a plurality of touch electrodes are arranged in the touch panel, and touch positions of a user can be detected via the touch electrodes. In the related art, when a touch device with the touch panel is in a weakly grounded state, for example, when the touch device is located on an insulated desktop or when the user uses the touch device lying on the bed, there will be touch drift or no touch response.

### SUMMARY

A touch panel provided by an embodiment of the present disclosure includes:

a base substrate; and

a touch electrode layer, disposed on the base substrate,

the touch electrode layer includes a plurality of touch electrodes and a plurality of dummy electrodes;

the plurality of dummy electrodes are insulated from the plurality of touch electrodes; and

at least part of the plurality of dummy electrodes in the touch electrode layer are grounded.

In some embodiments of the present disclosure, the touch panel further includes: a conductive connection layer located between the base substrate and the touch electrode layer, and an insulating layer located between the conductive connection layer and the touch electrode layer;

a conductive connection layer, arranged between the base substrate and the touch electrode layer; and

an insulating layer, arranged between the conductive connection layer and the touch electrode layer;

the conductive connection layer includes: a dummy electrode lead which is grounded;

the insulating layer includes: a plurality of first through holes; and

at least part of the plurality of dummy electrodes in the touch electrode layer are coupled with the dummy electrode lead via the first through holes.

In some embodiments of the present disclosure, at least part of the plurality of touch electrodes are provided with hollow areas, and the plurality of dummy electrodes are in the hollow areas.

In some embodiments of the present disclosure, geometric centers of the plurality of dummy electrodes coincide with geometric centers of the hollow areas.

In some embodiments of the present disclosure, the plurality of touch electrodes include a first electrode and a second electrode, the first electrode and the second electrode insulate each other and cross each other;

the first electrode includes: a plurality of first sub-electrodes arranged in a first direction; the conductive connection layer further includes: a plurality of bridging electrodes; the insulating layer further includes: a plurality of second through holes; in the first electrode, two adjacent first sub-electrodes are coupled with one of the plurality of bridging electrodes via the second through holes;

the second electrode includes: a plurality of second sub-electrodes arranged in a second direction, and the first direction and the second direction intersect with each other; the touch electrode layer further includes: a plurality of connection parts; in the second electrode, two adjacent second sub-electrodes are coupled with each other via one of the plurality of connection parts; and

the plurality of first sub-electrodes are provided with the hollow areas.

In some embodiments of the present disclosure, the second sub-electrodes are provided with the hollow areas.

In some embodiments of the present disclosure, edges of each of the plurality of first sub-electrodes are provided with a plurality of first protruding structures, and edges of each of the plurality of second sub-electrodes are provided with a plurality of second protruding structures; and

the plurality of first protruding structures and the plurality of second protruding structures are arranged in a staggered mode.

In some embodiments of the present disclosure, edges of each of the plurality of dummy electrodes are provided with a plurality of third protruding structures, and the hollow areas are provided with a plurality of recessed structures; and

the plurality of third protruding structures are arranged in the plurality of recessed structures.

In some embodiments of the present disclosure, the plurality of first electrode are touch driving electrodes, and the plurality of second electrodes are touch sensing electrodes; or

the plurality of first electrodes are touch sensing electrodes, and the plurality of second electrodes are touch driving electrodes.

In some embodiments of the present disclosure, the plurality of dummy electrodes have a same shape and size.

In some embodiments of the present disclosure, the plurality of dummy electrodes in the touch electrode layer are arranged in an array in the first direction and the second direction; the first direction and the second direction intersect with each other;

a plurality of dummy electrode leads are arranged in the conductive connection layer;

the plurality of dummy electrode leads extend in the first direction and are arranged in the second direction; and

each of the plurality of dummy electrode leads is coupled with a row of the plurality of dummy electrodes arranged in the first direction.

In some embodiments of the present disclosure, the conductive connection layer further includes: a conductive connection line extending in the second direction; and

the conductive connection line is coupled with at least two adjacent dummy electrode leads.

In some embodiments of the present disclosure, two conductive connection lines are arranged in the conductive connection layer; and

a part of the plurality of dummy electrode leads in the conductive connection layer are coupled with one of the conductive connection lines, and the other part of the plurality of dummy electrode leads are coupled with the other one of the conductive connection lines.

In some embodiments of the present disclosure, one conductive connection line is arranged in the conductive connection layer; and

each of the plurality of dummy electrode leads in the conductive connection layer is coupled with the conductive connection line.

In some embodiments of the present disclosure, the touch panel further includes:

a display module, arranged between the base substrate and the touch electrode layer;

an encapsulation layer, disposed on a side, close to the touch electrode layer, of the display module;

a polarizer, disposed on a side, facing away from the encapsulation layer, of the touch electrode layer;

a protective layer, disposed on a side, close to the polarizer, of the touch electrode layer, and

a cover plate, disposed on a side, facing away from the touch electrode layer, of the polarizer.

Accordingly, an embodiment of the present disclosure further provides a display apparatus, including any one of the above touch panels.

In some embodiments of the present disclosure, the display apparatus further includes: a flexible printed circuit; and

the flexible printed circuit includes a grounded end, and at least part of the plurality of dummy electrodes in the touch electrode layer are coupled with the grounded end.

In some embodiments of the present disclosure, the conductive connection layer includes: the plurality of dummy electrode leads and at least one conductive connection line; the plurality of dummy electrodes are coupled with the plurality of dummy electrode leads, and one of the at least one conductive connection line is coupled with at least two adjacent dummy electrode leads; and

the at least one conductive connection lines is coupled with the grounded end in the flexible printed circuit.

### BRIEF DESCRIPTION OF THE DRAWINGS

FIG. 1 is a schematic diagram of comparison of a touch effect between an ideal condition and an actual condition of a touch device in a related art under a weakly grounded state.

FIG. 2 is a schematic sectional view of a touch panel in an embodiment of the present disclosure.

FIG. 3 is a schematic planar structural diagram of a touch panel provided by an embodiment of the present disclosure.

FIG. 4 is a partially enlarged schematic diagram of the touch panel shown in FIG. 3.

FIG. 5 is another schematic planar structural diagram of a touch panel provided by an embodiment of the present disclosure.

FIG. 6 is a partially enlarged schematic diagram of the touch panel shown in FIG. 5.

FIG. 7 is another schematic planar structural diagram of a touch panel provided by an embodiment of the present disclosure.

FIG. 8 is another schematic planar structural diagram of a touch panel provided by an embodiment of the present disclosure.

FIG. 9 is another schematic sectional view of a touch panel in an embodiment of the present disclosure.

### DETAILED DESCRIPTION OF THE EMBODIMENTS

In order to make the purpose, technical solutions and advantages of the present disclosure clearer, the touch panel and the display apparatus provided by embodiments of the present disclosure will be described in further detail below with reference to the accompanying drawings. Obviously, the described embodiments are only part of embodiments of the present disclosure, not all of embodiments. Based on embodiments in the present disclosure, all other embodiments obtained by those of ordinary skill in the art without creative work shall fall within the protection scope of the present disclosure.

The shapes and sizes of various components in the accompanying drawings do not reflect the true ratio, and are only intended to illustrate the content of the present disclosure schematically.

In the related art, for a conventional touch panel, distances between a finger of a user and a touch layer, and between the touch layer and a display layer are large, when a device with the touch panel is in a weakly grounded state, a touch signal is affected slightly, and a touch position output by a touch chip is accurate.

However, with the development of a touch technology, the touch devices become lighter and thinner. For example, in an organic light-emitting diode (OLED) display apparatus, flexible multi-layer on cell (FMLOC) is adopted, which can set the touch layer inside the OLED display apparatus, so as to make the OLED display apparatus light and thin.

FIG. 1 is a schematic diagram of comparison of a touch effect between an ideal condition and an actual condition of a touch device under a weakly grounded state in the related art. In FIG. 1, a touch device adopting a mutual capacitance touch structure is used as an example for illustration, that is, the touch device includes a plurality of touch driving electrodes Tx and a plurality of touch sensing electrodes Rx, and the principle of adopting other types of touch structures is similar, which will not be illustrated one by one here.

As shown in (a) in FIG. 1, when the touch device is in the weakly grounded state, for example, when the touch device is on an insulated desktop or when the user uses the touch device lying on a bed, if an area of a contact region Q between the finger of the user and the touch device is large, for example, when the finger of the user is large or multiple fingers make contact with the same touch driving electrode Tx (or the touch sensing electrode Rx) at the same time, ideally, a touch signal strength detected by the touch sensing electrode Rx shall be concentrated at a center position of the contact region Q, so that the touch chip outputs coordinates of one touch position q. However, as shown in (b) in FIG. 1, when the touch device is in the weakly grounded state, due to the weak grounding of the touch device, charges between the touch driving electrodes Tx and the touch sensing electrodes Rx cannot be well transferred to the ground via a human body, consequently, when the area of the contact region Q between the finger of the user and the touch device is large, there will be touch drift or no touch response. Therefore, actually, the touch signal strength detected by the touch sensing electrode Rx is weak and scattered, which causes the touch chip to output the coordinates of multiple touch positions q, that is, multi-point false alarms, thus resulting in poor touch performance, and affecting use experience of the user.

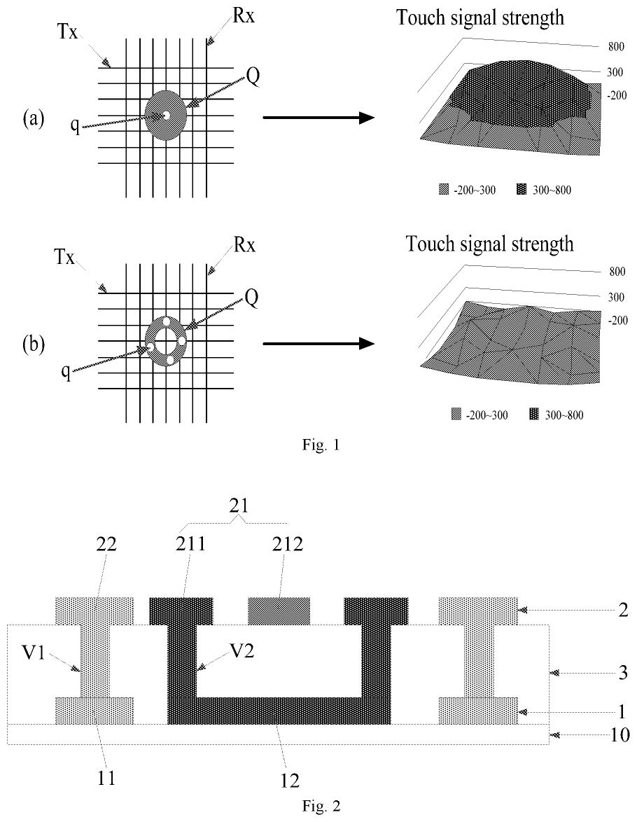

In view of this, embodiments of the present disclosure provide a touch panel and a display apparatus. FIG. 2 is a schematic sectional view of a touch panel in an embodiment of the present disclosure. As shown in FIG. 2, the touch panel provided by embodiments of the present disclosure may include:

a base substrate 10;

a touch electrode layer 2, disposed on the base substrate 10;

the touch electrode layer 2 includes a plurality of touch electrodes 21 and a plurality of dummy electrodes 22;

the plurality of dummy electrodes 22 are insulated from the plurality of touch electrodes 21; and

at least part of the plurality of dummy electrodes 22 in the touch electrode layer 2 are grounded.

In the touch panel provided by embodiments of the present disclosure, the dummy electrodes 22 insulated from the touch electrodes 21 are arranged in the touch electrode layer 2, so that when the touch panel is used in a normal grounded condition, the arrangement of the dummy electrodes 22 can enlarge the touch region, such that more sensing regions are capable of sensing touch operations of the user with high sensitivity, thereby enhancing touch sensitivity. In addition, when the touch panel is used in the weakly grounded condition (for example, when the touch panel is placed on the desktop or the user is lying on the bed, etc.), since at least part of the dummy electrodes 22 in the touch electrode layer 2 are grounded, when the touch panel is used in the weakly grounded condition, charges between the touch electrodes 21 may be transferred to the dummy electrodes 22 via the finger, the dummy electrodes 22 are grounded, so that the charges between the touch electrodes 21 may be well transferred to the ground, which accordingly increases the signal strength detected by the touch electrodes 21, thereby enabling touch chips to output accurate touch positions, and improving user touch experience.

In some embodiments of the present disclosure, reference to FIG. 2, may further include:

a conductive connection layer 1, arranged between the base substrate 10 and the touch electrode layer 2, and

an insulating layer 3, arranged between the conductive connection layer 1 and the touch electrode layer 2;

the conductive connection layer 1 includes: a dummy electrode lead 11 which is grounded;

the insulating layer 3 includes: a plurality of first through holes V1; and

at least part of the plurality of dummy electrodes 22 in the touch electrode layer 2 are coupled with the dummy electrode lead 11 via the first through holes V1.

In some embodiments of the present disclosure, the dummy electrodes 22 are coupled with the dummy electrode lead 11 via the first through holes V1 in the insulating layer 3, since the dummy electrode lead 11 is grounded, the dummy electrodes 22 are grounded, and the quantity of the lead in the touch electrode layer 2 is reduced. Moreover, the conductive connection layer 1 is arranged on a side of the touch electrode layer 2 close to the base substrate 10, so that a distance between the touch electrode layer 2 and a touch face of the touch panel is small, in this way, the touch operations of the user may be detected more sensitively, and the touch effect is better. In addition, in some implementations, the conductive connection layer 1 may also be arranged on a side of the touch electrode layer 2 facing away from the base substrate 10, which is not limited here.

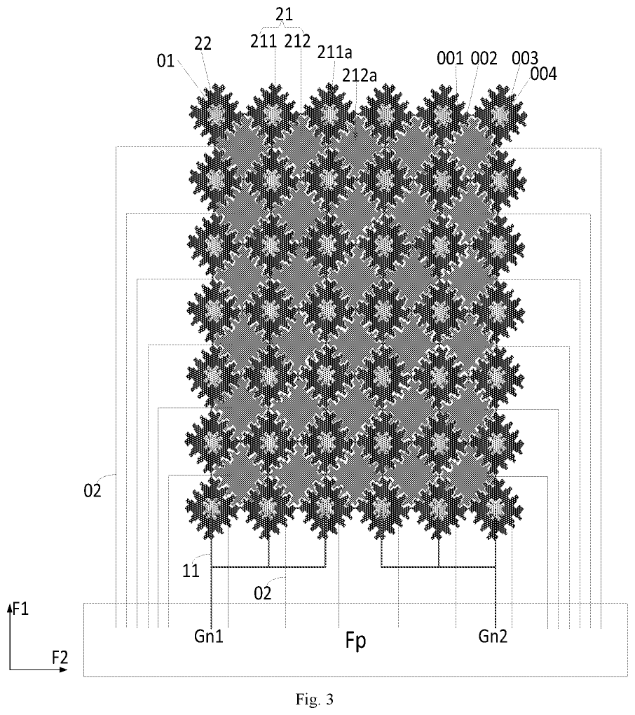

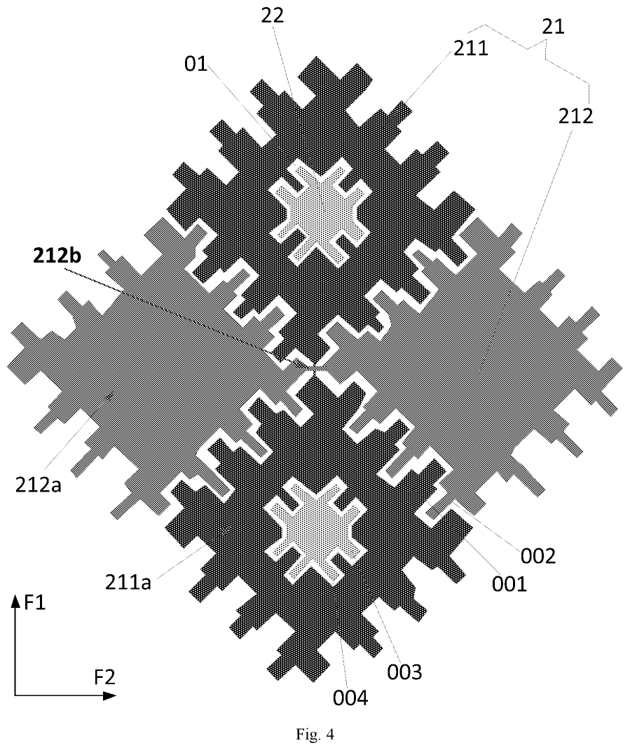

In some embodiments, since the smaller an area of the touch electrodes, the smaller the capacitance of the touch electrodes to the ground and the smaller the power consumption of the touch panel, in order to reduce the power consumption of the touch panel, in the touch panel provided by embodiments of the present disclosure, FIG. 3 is a schematic planar structural diagram of the touch panel provided by embodiments of the present disclosure, FIG. 4 is a partial enlarged schematic diagram of FIG. 3, as shown in FIG. 3 and FIG. 4, at least part of the plurality of touch electrodes 21 have hollow areas 01, and the plurality of dummy electrodes 22 are in the hollow areas 01. In this way, it can be ensured that a touch detection effect of the touch panel in the weakly grounded state is good, and the power consumption of the touch panel can further be reduced. Reference to FIG. 4, in the touch panel provided by some embodiments of the present disclosure, geometric centers of the dummy electrodes 22 coincide with geometric centers of the hollow areas 01.

In some embodiments, as shown in FIG. 2, FIG. 3 and FIG. 4, the touch electrodes 21 include a first electrode 211 and a second electrode 212, the first electrode 211 and the second electrode 212 insulate each other and cross each other, that is, the touch electrodes 21 in some embodiments of the present disclosure are of a mutual capacitance structure. In some embodiments, the touch electrodes 21 may also adopt a self-capacitance structure, which is not limited here.

The first electrode 211 includes: a plurality of first sub-electrodes 211a arranged in a first direction F1; the conductive connection layer 1 further includes: a plurality of bridging electrodes 12; the insulating layer 3 further includes: a plurality of second through holes V2; in the first electrode 211, two adjacent first sub-electrodes 211a are coupled with one of the plurality of bridging electrodes 12 via the second through holes V2.

The second electrode 212 includes: a plurality of second sub-electrodes 212a arranged in a second direction F2, and the first direction F1 and the second direction F2 intersect with each other; the touch electrode layer 2 further includes: a plurality of connection parts 212b; in the second electrode 212, two adjacent second sub-electrodes 212a are coupled with each other via one of the plurality of connection parts 212b.

In some embodiments of the present disclosure, the bridging electrodes 12 are arranged in the conductive connection layer 1, the two adjacent first sub-electrodes 211a may be coupled with the bridging electrodes 12 via the second through holes V2, so that all the first sub-electrodes 211a in the first electrode 211 may be coupled with each other, moreover, the bridging electrodes 12 and the dummy electrode leads 11 are arranged on the same film layer, in the manufacturing process, the bridging electrodes 12 and the dummy electrode leads 11 may be manufactured by one-time patterning process, and a manufacturing cost is saved. The connection parts 212b are arranged in the touch electrode layer 2, the two adjacent second sub-electrodes 212a may be coupled with each other via the connection parts 212b, so that all the second sub-electrodes 212a in the second electrode 212 may be coupled with each other. In this way, the first electrode 211 and the second electrode 212 may be manufactured in the same touch electrode layer 2, and the manufacturing procedure and the cost can be reduced.

In some embodiments of the present disclosure, the situation that all the first sub-electrodes in the first electrode are coupled with each other via the bridging electrodes, and all the second sub-electrodes in the second electrode are coupled with each other via the connection parts is taken as an example for illustration. In some embodiments, all the first sub-electrodes in the first electrode may also be coupled with each other via the connection parts, and all the second sub-electrodes in the second electrode may also be coupled with each other via the bridging electrodes, which is not limited here.

As shown in FIG. 3 and FIG. 4, the plurality of first sub-electrodes 211a are provided with the hollow areas 01. In this way, the dummy electrodes 22 may be arranged in the hollow areas 01, on one hand, the capacitance of the first electrode 211 to the ground is reduced, and the power consumption of the touch panel is reduced; and on the other hand, charges between the touch electrodes 21 may be transferred to the dummy electrodes 22 via the finger, the dummy electrodes are grounded, so that the charges between the touch electrodes 21 may be well transferred to the ground, which accordingly increases the signal strength detected by the touch electrodes 21, thereby enabling the touch chips to output accurate touch positions, and improving user touch experience.

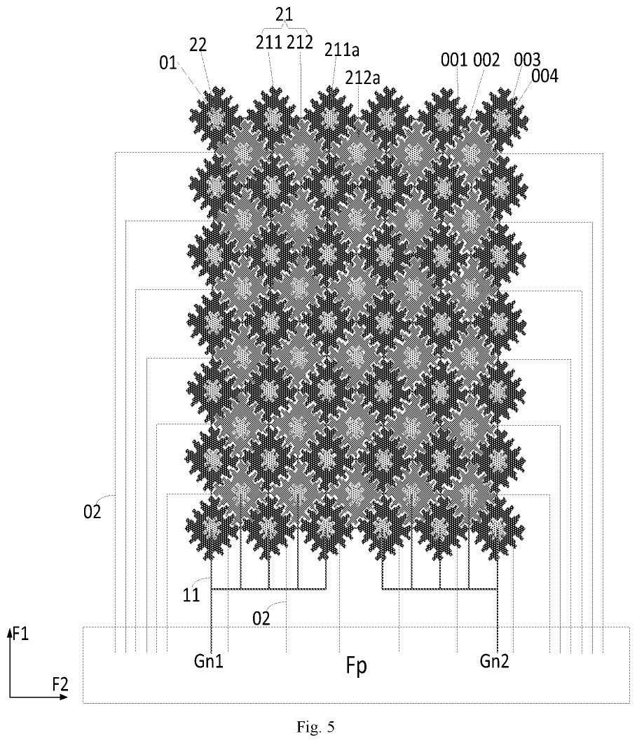

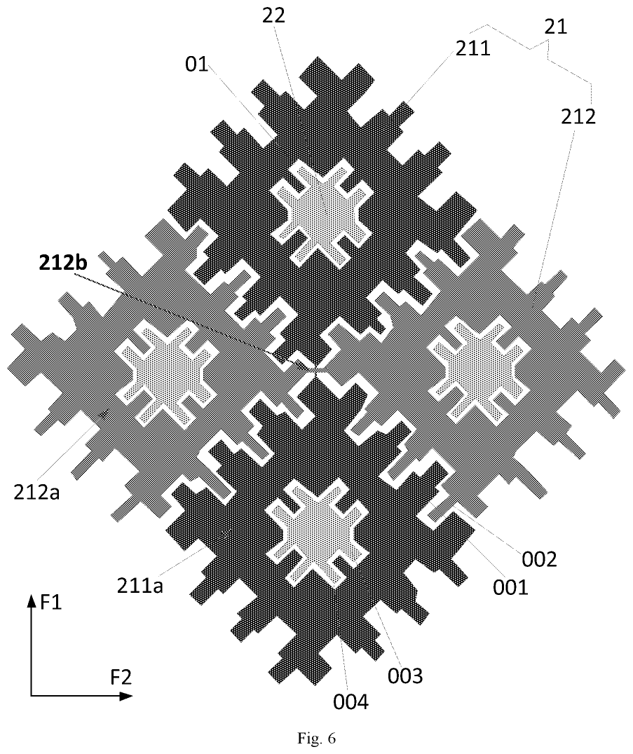

In some embodiments of the present disclosure, as shown in FIG. 5 and FIG. 6, FIG. 5 is another schematic planar structural diagram of the touch panel provided by the embodiment of the present disclosure, FIG. 6 is a partial enlarged schematic diagram of FIG. 5, and the second sub-electrodes 212 are provided with the hollow areas 01. In this way, the capacitance of the second electrode 212 to the ground can be reduced, the power consumption of the touch panel is further reduced, moreover, the first sub-electrodes 211a and the second sub-electrodes 212a all have the hollow areas 01, so that in the whole touch panel, the dummy electrodes 22 arranged in the hollow areas 01 can be more uniform, each touch position in the touch panel may detect a strong signal quantity, and there will be no multi-point false alarms for each touch position of the whole touch panel, which further improves the user touch experience.

In some embodiments of the present disclosure, as shown in FIG. 3 and FIG. 5, may further include: a touch electrode lead 02, and the touch electrode lead 02 couples the touch electrodes 21 with the touch chips.

In some embodiments, in order to further reduce the power consumption of the touch panel, as shown in FIG. 3 to FIG. 6, edges of each of the plurality of first sub-electrodes 211a are provided with a plurality of first protruding structures 001, and edges of each of the plurality of second sub-electrodes 212a are provided with a plurality of second protruding structures 002; and the plurality of first protruding structures 001 and the plurality of second protruding structures 002 are arranged in a staggered mode.

That is, the edges of the first sub-electrodes 211a and the second sub-electrodes 212a are of a sawtooth structure, in this way, the sheet resistance of the first electrode 211 and the second electrode 212 can be reduced, thereby reducing the power consumption of the touch panel.

In some embodiments, in order to further reduce the power consumption of the touch panel, as shown in FIG. 3 to FIG. 6, edges of each of the plurality of dummy electrodes 22 are provided with a plurality of third protruding structures 003, and the hollow areas 01 are provided with a plurality of recessed structures 004; and the plurality of third protruding structures 003 are arranged in the plurality of recessed structures 004.

That is, the edges of the dummy electrodes 22 and the hollow areas 01 are of a sawtooth structure, in this way, the sheet resistance of the dummy electrodes 22 can be reduced, thereby further reducing the power consumption of the touch panel.

It should be noted that the sawtooth structure mentioned above is not necessarily a regular sawtooth structure, as long as the edge has a toothed structure.

In some embodiments, in order to facilitate unified manufacture, as shown in FIG. 3 to FIG. 6, the geometric center of the dummy electrodes 22 coincides with the geometric center of the first sub-electrodes 211a (or the second sub-electrodes 212a). In some embodiments, the geometric center of the dummy electrodes 22 in the first sub-electrodes 211a coincides with the geometric center of the first sub-electrodes 211a, and the geometric center of the dummy electrodes 22 in the second sub-electrodes 212a coincides with the geometric center of the second sub-electrodes 212a.

Of course, in some embodiments, the geometric center of the dummy electrodes may coincide or not coincide with the first sub-electrodes (or the second sub-electrodes), as long as the dummy electrodes are insulated from the touch electrodes.

In some embodiments, the plurality of first electrode are touch driving electrodes, and the plurality of second electrodes are a touch sensing electrodes; or the plurality of first electrodes are a touch sensing electrodes, and the plurality of second electrodes are a touch driving electrodes.

In some embodiments, in order to facilitate unified manufacture process, as shown in FIG. 3 to FIG. 6, the dummy electrodes 22 have a same shape and size. Of course, the dummy electrodes 22 may also have different shapes and sizes.

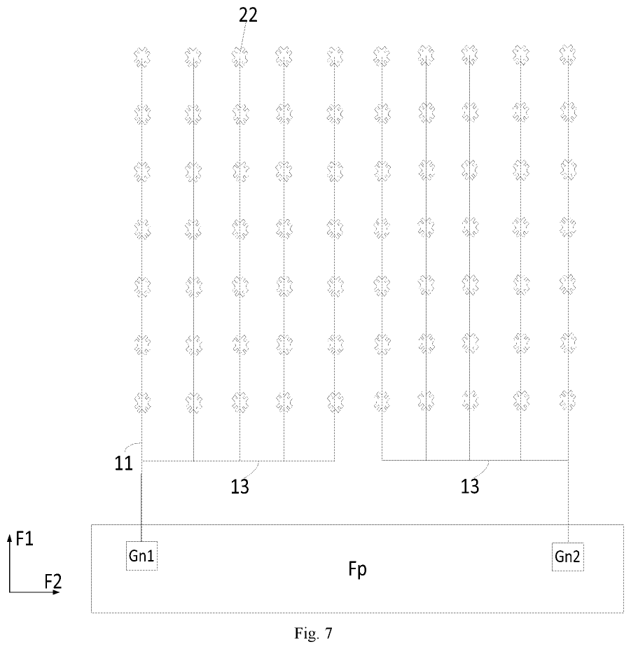

FIG. 7 is another schematic planar structural diagram of the touch panel provided by embodiments of the present disclosure. In order to clearly illustrate a connection relationship between the dummy electrodes and the dummy electrode leads, all the touch electrodes are omitted in figure. As shown in FIG. 7, the plurality of dummy electrodes 22 in the touch electrode layer are arranged in an array in the first direction F1 and the second direction F2; the first direction F1 and the second direction F2 intersect with each other;

a plurality of dummy electrode leads 11 are arranged in the conductive connection layer, and the plurality of dummy electrode leads 11 extend in the first direction F1 and are arranged in the second direction F2; and each of the plurality of dummy electrode leads 11 is coupled with a row of the plurality of dummy electrodes 22 arranged in the first direction F1.

In some embodiments, all the dummy electrodes 22 in the touch electrode layer are arranged in an array, and each dummy electrode lead 11 is coupled with a row of dummy electrodes 22 arranged in the first direction F1, so that all the dummy electrodes 22 are conveniently led out. In addition, all the dummy electrodes 22 in the touch electrode layer may also be arranged in other modes, which is not limited here.

In some embodiments, referring to FIG. 7, the above conductive connection layer may further include: a conductive connection line 13 extending in the second direction F2; and the conductive connection line 13 is coupled with two adjacent dummy electrode leads 11. In practical application, the touch panel may be coupled with a flexible printed circuit Fp, and grounded signals are provided for all the dummy electrodes 22 via a grounded end (such as Gn1 or Gn2 in FIG. 7). All the dummy electrode leads 11 coupled with the conductive connection line 13 may be coupled with the same grounded end in the flexible printed circuit Fp, and the quantity of the leads connected with the grounded end is reduced, so as to facilitate wiring.

With continued reference to FIG. 7, in some embodiments of the present disclosure, two conductive connection lines 13 may be arranged in the conductive connection layer; and a portion of the dummy electrode leads 11 in the conductive connection layer are coupled with one of the conductive connection lines 13, and the other portion of the dummy electrode leads 11 are coupled with the other one of the conductive connection lines 13. For example, among all the dummy electrode leads 11, half of the dummy electrode leads 11 which are continuously arranged are coupled with one conductive connection line 13 and a first grounded end Gn1 in the flexible printed circuit Fp; and the other half of the dummy electrode leads 11 which are continuously arranged are coupled with the other conductive connection line 13 and a second grounded end Gn2 in the flexible printed circuit Fp.

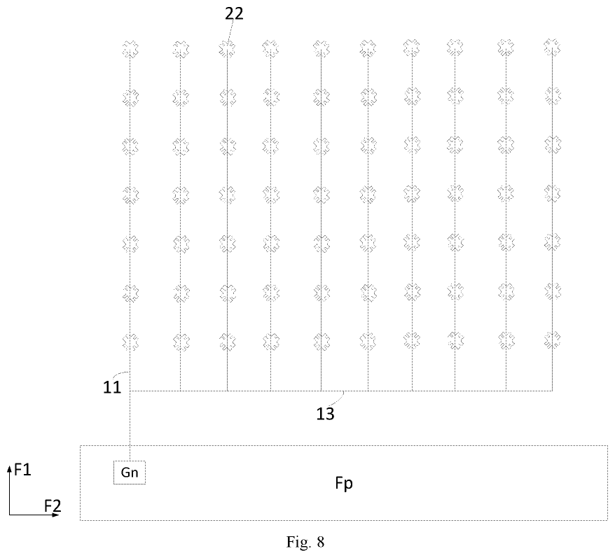

FIG. 8 is another schematic planar structural diagram of the touch panel provided by embodiments of the present disclosure. In order to clearly illustrate a connection relationship between the dummy electrodes and the dummy electrode leads, all the touch electrodes are omitted in figure. As shown in FIG. 8, one conductive connection line 13 is arranged in the conductive connection layer, and all the dummy electrode leads 11 in the conductive connection layer are coupled with the conductive connection line 13. In this way, all the dummy electrode leads 11 are coupled with the same grounded end Gn in the flexible printed circuit Fp.

In some embodiments of the present disclosure, the situation that one or two conductive connection lines are arranged in the conductive connection layer is taken as an example for illustration. In some embodiments, more conductive connection lines may also be arranged in the conductive connection layer, which is not limited here.

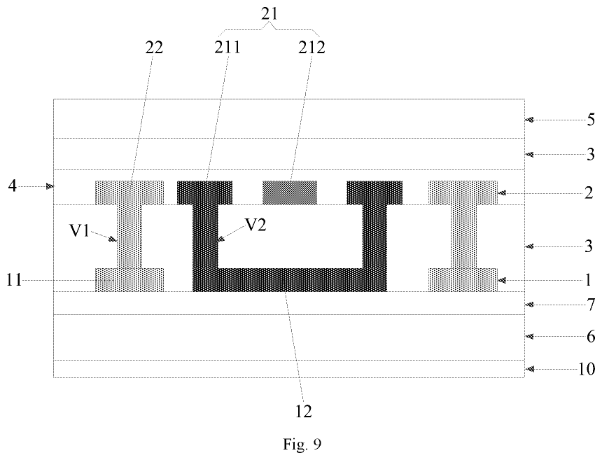

FIG. 9 is another schematic sectional view of the touch panel in embodiments of the present disclosure. As shown in FIG. 9, the touch panel may further include: a display module 6 located between the base substrate 10 and the touch electrode layer 2, an encapsulation layer 7 disposed on a side of the display module 6 close to the touch electrode layer 2, a polarizer 3 disposed on a side of the touch electrode layer 2 facing away from the encapsulation layer, a protective layer 4 disposed on a side of the touch electrode layer 2 close to the polarizer 3, and a cover plate 5 disposed on a side of the polarizer 3 facing away from the touch electrode layer 2.

In some embodiments, the above display module 6 may be an organic electroluminescent diode display panel, the display module 6 may include an anode, a cathode and a light-emitting layer arranged between the anode and the cathode, and electric signals are applied to the anode and the cathode, so as to control the light-emitting layer to emit light. The encapsulation layer 7 is arranged on the side of the display module 6 close to the touch electrode layer 2, so that the light-emitting layer can be prevented from being eroded by external water vapor and oxygen. The above polarizer 3 may be a circular polarizer, which can reduce a reflectivity of external light and improve the display effect of the display module 6. The protective layer 4 has a function of protecting the touch electrode layer 2 and the conductive connection layer 1. In some embodiments, a material of the protective layer 4 may be silicon oxynitride. The cover plate 5 can protect an internal structure of the touch panel. In addition, the display module 6 may also be other types of display panels, which is not limited here.

That is, the touch panel provided by embodiments of the present disclosure may be touch panel only with a touch function, and may also be a touch display panel with a display function.

Based on the same inventive concept, an embodiment of the present disclosure further provides a display apparatus, including the above any touch panel provided by embodiments of the present disclosure. The implementation of the display apparatus may refer to the implementation of the above touch panel, and the repetition will not be made.

In some embodiments, as shown in FIG. 7 and FIG. 8, the display apparatus may further include: a flexible printed circuit Fp, the flexible printed circuit Fp includes a grounded end, for example, in FIG. 7, the flexible printed circuit Fp includes a first grounded end Gn1 and a second grounded end Gn2, and in FIG. 8, the flexible printed circuit Fp includes one grounded end Gn. At least part of the dummy electrodes 22 in the touch electrode layer are coupled with the grounded end. In this way, grounded signals may be provided for all the dummy electrodes 22 via the grounded end in the flexible printed circuit Fp, so as to realize the grounded arrangement of the dummy electrodes 22.

With continued reference to FIG. 7 and FIG. 8, in the display apparatus provided by embodiments of the present disclosure, the conductive connection layer may include: the plurality of dummy electrode leads 11 and at least one conductive connection line 13; the plurality of dummy electrodes 22 are coupled with the plurality of dummy electrode leads 11, and one of the at least one conductive connection line 13 is coupled with at least two adjacent dummy electrode leads 11; and the at least one conductive connection line 13 is coupled with the grounded end in the flexible printed circuit Fp. The dummy electrode leads 11 and the conductive connection line 13 are arranged, so that the dummy electrodes 22 may be connected to the grounded end of the flexible printed circuit Fp.

In the specific implementation, the connection mode of the dummy electrode leads is not limited to FIG. 8 and FIG. 9, and the dummy electrode leads may further be electrically connected with more grounded ends, which belong to the protection scope of the present disclosure.

In some embodiments of the present disclosure, in order to prove that the grounded arrangement of the dummy electrodes can improve the touch effect, the display apparatus in the embodiment of the present disclosure is placed in the weakly grounded state for use, the situations that the dummy electrodes are grounded and the dummy electrodes are suspended (no signal is applied to the dummy electrodes) are simulated respectively, and obtained simulation data are shown in table 1.

TABLE 1

| | The dummy electrodes | The dummy electrodes |
|---|---|---|
| | are suspended | are grounded |
| Cp (Tx_unit) | 10.864 | 10.688 |
| Cp (Rx_unit) | 11.092 | 10.876 |
| Cm (w/o finger) | 0.644 | 0.640 |
| Cm1 (w/finger) | 0.484 | 0.456 |
| ΔCm (Cm-Cm1) | 0.16 | 0.184 |
| ΔCm/Cm | 24.84% | 28.75% |
| Cp (Tx_finger) | 0.988 | 0.856 |
| Cp (Rx_finger) | 1.008 | 0.882 |
| LGM index | 0.321 | 0.424 |

Cp (Tx_unit) is a capacitance of a touch driving electrode to the ground, Cp (Rx_unit) is a capacitance of a touch sensing electrode to the ground, Cm (w/o finger) is a capacitance between touch electrodes without finger touch, Cml (w finger) is a coupling capacitance between the touch electrodes and fingers with finger touch, Cp (Tx_finger) is a coupling capacitance between the touch driving electrode and the fingers, and Cp (Rx_finger) is a coupling capacitance between the touch sensing electrode and the fingers. As can be seen from table 1, ΔCm when the dummy electrodes are grounded is greater than that when the dummy electrodes are suspended, and the touch signal quantity (LGM Index) when the dummy electrodes are grounded is greater than that when the dummy electrodes are suspended. Therefore, the display apparatus with grounded dummy electrodes provided by the embodiment of the present disclosure is good in touch performance, the touch chips may output accurate touch positions, and there will be no multi-point false alarm, thereby improving user touch experience.

The display apparatus may be any products or components with display functions such as a mobile phone, a tablet computer, a television, a monitor, a notebook computer, a digital photo frame, a navigator, etc.

In the touch panel and the display apparatus provided by embodiments of the present disclosure, the dummy electrodes insulated from the touch electrodes are arranged in the touch electrode layer, when the touch panel is used in the normal grounded condition, the arrangement of the dummy electrodes can enlarge the touch region, such that more sensing regions can sense the touch operations of the user with high sensitivity, thereby improving the touch sensitivity; and when the touch panel is used in the weakly grounded condition (for example, when the touch panel is placed on the desktop or the user is lying on the bed, etc.), since at least part of the dummy electrodes in the touch electrode layer are grounded, when the touch panel is used in the weakly grounded condition, the charges between the touch electrodes may be transferred to the dummy electrodes via the finger, the dummy electrodes are grounded, so that the charges between the touch electrodes may be well transferred to the ground, which accordingly increases the signal strength detected by the touch electrodes, thereby enabling touch chips to output accurate touch positions, and improving user touch experience.

Obviously, those skilled in the art can make various modifications and variations to the present disclosure without departing from the spirit and scope of the present disclosure. As such, provided that these modifications and variations of the present disclosure fall within the scope of the claims of the present disclosure and their equivalents, the present disclosure is also intended to cover such modifications and variations.

1. A touch panel, comprising:
a base substrate; and
a touch electrode layer, disposed on the base substrate, wherein
the touch electrode layer comprises a plurality of touch electrodes and a plurality of dummy electrodes;
the plurality of dummy electrodes are insulated from the plurality of touch electrodes; and
at least part of the plurality of dummy electrodes in the touch electrode layer are grounded.

2. The touch panel according to claim 1, further comprising:
a conductive connection layer, arranged between the base substrate and the touch electrode layer; and
an insulating layer, arranged between the conductive connection layer and the touch electrode layer; wherein
the conductive connection layer comprises: a dummy electrode lead which is grounded;
the insulating layer comprises: a plurality of first through holes; and
at least part of the plurality of dummy electrodes in the touch electrode layer are coupled with the dummy electrode lead via the first through holes.

3. The touch panel according to claim 2, wherein at least part of the plurality of touch electrodes have hollow areas, and
the plurality of dummy electrodes are in the hollow areas.

4. The touch panel according to claim 3, wherein geometric centers of the plurality of dummy electrodes coincide with geometric centers of the hollow areas.

5. The touch panel according to claim 3, wherein the plurality of touch electrodes comprise a first electrode and a second electrode, the first electrode and the second electrode insulate each other and cross each other;
the first electrode comprises: a plurality of first sub-electrodes arranged in a first direction; the conductive connection layer further comprises: a plurality of bridging electrodes; the insulating layer further comprises: a plurality of second through holes; in the first electrode, two adjacent first sub-electrodes are coupled with one of the plurality of bridging electrodes via the second through holes;
the second electrode comprises: a plurality of second sub-electrodes arranged in a second direction, and the first direction and the second direction intersect with each other; the touch electrode layer further comprises: a plurality of connection parts; in the second electrode, two adjacent second sub-electrodes are coupled with each other via one of the plurality of connection parts; and
the plurality of first sub-electrodes are provided with the hollow areas.

6. The touch panel according to claim 5, wherein the second sub-electrodes are provided with the hollow areas.

7. The touch panel according to claim 5, wherein edges of each of the plurality of first sub-electrodes are provided with a plurality of first protruding structures, and edges of each of the plurality of second sub-electrodes are provided with a plurality of second protruding structures; and
the plurality of first protruding structures and the plurality of second protruding structures are arranged in a staggered mode.

8. The touch panel according to claim 7, wherein edges of each of the plurality of dummy electrodes are provided with a plurality of third protruding structures, and the hollow areas are provided with a plurality of recessed structures; and
the plurality of third protruding structures are arranged in the plurality of recessed structures.

9. The touch panel according to claim 5, wherein the plurality of first electrode are touch driving electrodes, and the plurality of second electrodes are touch sensing electrodes; or
the plurality of first electrodes are touch sensing electrodes, and the plurality of second electrodes are touch driving electrodes.

10. The touch panel according to claim 1, wherein the plurality of dummy electrodes have a same shape and size.

11. The touch panel according to claim 2, wherein the plurality of dummy electrodes in the touch electrode layer are arranged in an array in a first direction and a second direction; the first direction and the second direction intersect with each other;
a plurality of dummy electrode leads are arranged in the conductive connection layer;
the plurality of dummy electrode leads extend in the first direction and are arranged in the second direction; and
each of the plurality of dummy electrode leads is coupled with a row of the plurality of dummy electrodes arranged in the first direction.

12. The touch panel according to claim 11, wherein the conductive connection layer further comprises: a conductive connection line extending in the second direction; and
the conductive connection line is coupled with at least two adjacent dummy electrode leads.

13. The touch panel according to claim 12, wherein two conductive connection lines are arranged in the conductive connection layer; and
a part of the plurality of dummy electrode leads in the conductive connection layer are coupled with one of the conductive connection lines, and the other part of the plurality of dummy electrode leads are coupled with the other one of the conductive connection lines.

14. The touch panel according to claim 12, wherein one conductive connection line is arranged in the conductive connection layer; and
each of the plurality of dummy electrode leads in the conductive connection layer is coupled with the conductive connection line.

15. The touch panel according to claim 1, further comprising:
a display module, arranged between the base substrate and the touch electrode layer;
an encapsulation layer, disposed on a side, close to the touch electrode layer, of the display module;
a polarizer, disposed on a side, facing away from the encapsulation layer, of the touch electrode layer;
a protective layer, disposed on a side, close to the polarizer, of the touch electrode layer, and
a cover plate, disposed on a side, facing away from the touch electrode layer, of the polarizer.

16. A display apparatus, comprising the touch panel according to claim 1.

17. The display apparatus according to claim 16, further comprising: a flexible printed circuit; and
the flexible printed circuit comprises a grounded end, and at least part of the plurality of dummy electrodes in the touch electrode layer are coupled with the grounded end.

18. The display apparatus according to claim 17, wherein the conductive connection layer comprises: the plurality of dummy electrode leads and at least one conductive connection line; the plurality of dummy electrodes are coupled with the plurality of dummy electrode leads, and one of the at least one conductive connection line is coupled with at least two adjacent dummy electrode leads; and
the at least one conductive connection lines is coupled with the grounded end in the flexible printed circuit.

19. The display apparatus according to claim 16, further comprising:
a conductive connection layer, arranged between the base substrate and the touch electrode layer; and
an insulating layer, arranged between the conductive connection layer and the touch electrode layer; wherein
the conductive connection layer comprises: a dummy electrode lead which is grounded;
the insulating layer comprises: a plurality of first through holes; and
at least part of the plurality of dummy electrodes in the touch electrode layer are coupled with the dummy electrode lead via the first through holes.

20. The display apparatus according to claim 19, wherein at least part of the plurality of touch electrodes have hollow areas, and
the plurality of dummy electrodes are in the hollow areas.
